(19) United States
(12) Patent Application Publication
(10) Pub. No.: US 2006/0106659 A1
(43) Pub. Date: May 18, 2006

(54) System and method for monitoring and analyzing data trends of interest within an organization

(76) Inventors: Susan R. Santos, Ft. Leavenworth, KS (US); Stephen D. Simon, Shawnee Mission, KS (US); Karen Cox, Kansas City, MO (US)

Correspondence Address: HOVEY WILLIAMS LLP, 2405 GRAND BLVD., SUITE 400, KANSAS CITY, MO, 64108, US

(21) Appl. No.: 11/256,326

(22) Filed: Oct. 21, 2005

Related U.S. Application Data
(62) Division of application No. 09/751,858, filed on Dec. 29, 2000.

(51) Int. Cl. G06F 17/50

(52) U.S. Cl. 705/7

(57) ABSTRACT

A system and method for identifying, monitoring, and analyzing various trends and patterns of interest within an organization in order to maximize aspects thereof, including, for example, productivity, efficiency, and employee health and safety. The invention utilizes a centralized data repository to accessibly store and maintain data; date gap analysis to avoid aggregation on calender or other artificial boundaries; control chart analysis to allow for easy understanding of the data; workload adjustments to avoid false indicators; tabular and graphical data displays which facilitates identifying anomalous data and monitoring for data quality; and a drill down mechanism for investigating trends and anomalous data points in detail. Analysis may be performed on various normalized data sets and the results simultaneously displayed to allow comparison and easier identification of interrelated variables and, thereby, of cause and effect. The effectiveness of remedies and intervention schemes may also be monitored and analyzed.

### RELATED APPLICATIONS

The present application is a divisional patent application of earlier-filed U.S. nonprovisional patent applications titled “A SYSTEM AND METHOD FOR MONITORING AND ANALYZING DATA TRENDS OF INTEREST WITHIN AN ORGANIZATION”, Ser. No. 09/751,858, filed Dec. 29, 2000. The present application claims priority benefit of the earlier-filed application, and the identified earlier-filed application is hereby incorporated by reference into the present application.

### BACKGROUND OF THE INVENTION

1. Field of the Invention

The present invention relates to systems and methods for monitoring and analyzing trends and patterns of interest within an organization. More particularly, the present invention relates to a computer-based surveillance and analysis tool for identifying, monitoring, and analyzing trends and patterns of interest within an organization, and having features allowing for more detailed investigation and analysis of specific data or ranges of data identified and selected from a larger trend or pattern.

2. Description of the Prior Art

As will be appreciated by those with skill in the art, it is desirable to identify, monitor, and analyze various trends and patterns of interest within an organization in order to improve organizational effectiveness. Existing systems and methods typically consist of stand-alone administrative software narrowly designed for a particular business or industry, or a combination of administrative software and general-purpose statistical analysis software, both of which suffer from a number of disadvantages.

Stand-alone administrative software systems are typically unable to integrate data from different but related sources because each administrative system stores its own data in isolation and uses incompatible coding systems. There may be, for example, separate systems for tracking workplace injuries and illnesses, production line errors, consumer complaints, and employee turnover, and no way to integrate the various systems and data to uncover relationships. Though combining the administrative software with statistical software may make possible the integration of data from multiple sources, doing so often requires difficult and labor intensive data translations, and, even after the data is translated, inconsistencies in coding information may remain.

Stand-alone administrative software systems typically rely on artificial boundaries for aggregating event data, which may mask the development of new and interesting trends. If such a trends happens to begin in the middle of a reporting period, the first manifestation may be averaged away by the earlier data of that same period. These artificial boundaries may also undesirably delay the reporting of information. Identifying a sudden shift in employee accidents, for example, may not be possible until the end of the reporting period, whether the period is a month or a quarter or longer.

Furthermore, it can be difficult to effectively model data received on a monthly or quarterly basis rather than a daily or even constant basis. One known solution is to model the data as a Poisson distribution using a C chart, which is a control chart for Poisson data. The C chart can be used to monitor events like employee injuries and illnesses by simply counting the number of events in some time interval and treating these counts as if they came from a Poisson distribution. Unfortunately, there are several problems with this approach, including that employee injuries and illnesses may not meet all of the assumptions for a Poisson distribution; the time interval is arbitrary and makes chart comparison difficult; and C charts may have difficulty detecting particularly rare illnesses or injuries. Thus, though useful in analyzing data of interest, control chart analysis is limited when based upon monthly or quarterly reports.

Many stand-alone administrative software systems also fail to produce appropriate reports. The output of these systems is typically a rigid tabular format with few, if any, graphical output options. Unfortunately, though combining statistical software will generally produce a wider variety of graphs and reports than stand-alone administrative software, the variety may be so broad and the choices so complex as to require extensive training merely to understand the options.

Furthermore, each report typically focuses on a single, isolated data series. In a hospital setting, for example, a manager or other administrator desiring to compare and relate medication errors, employee workload, number of patients seen, and number of medications dispensed would have to generate a separate report for each data series and then physically compare the reports side-by-side in order to identify common trends and patterns.

When patterns are identifiable from a comparison of several disparate reports, the system frustrates further attempts to investigate these trends. That is, existing administrative software systems typically fail to provide a simple and efficient mechanism for delving into greater levels of detail to uncover possible causes of the trends or patterns of interest, and incompatible coding schemes or formats may make such detailed investigation difficult or impossible. Combining general-purpose statistical software is likely to be of no help as it also fails to provide for a simple method of detailed investigation of trends and patterns of interest to identify underlying causes. Those statistical-based methods that do attempt to provide this ability are complex and require extensive training to use effectively.

Additionally, administrative software systems typically do not have any built-in data quality checks. For example, there may be no way to detect a reporting gap, such as may occur when employees fail to report production errors because their workload is too heavy. Again, combining general-purpose statistical software is likely to be of little help as it typically includes no automated data quality checks to identify, for example, reporting gaps, making the software only as good as the data provided to it.

Due to the above identified problems and shortcomings in the existing art, an improved system and method is needed to allow for more efficient and effective identification and analysis of organizational trends and patterns of interest.

### SUMMARY OF THE INVENTION

The system and method of the present invention provide unique features that overcome many of the problems experienced in the art of identifying, monitoring, and analyzing various trends and patterns of interest within an organization in order to maximize valued aspects thereof, including, for example, productivity, efficiency, and employee health and safety. More specifically, the present invention utilizes a centralized data repository to accessibly store and maintain data; date gap analysis to avoid aggregation on calender or other artificial boundaries; control chart analysis to allow for easy understanding of the data; workload adjustments to avoid false indicators; tabular and graphical data displays which facilitates identifying anomalous data and monitoring for data quality; and a drill down mechanism for investigating trends and anomalous data points in detail.

All data streams are entered into a centralized data repository for storage in a common format, thereby allowing for immediate availability and fully-integratable use. Date gap analysis techniques are used to eliminate artificial boundaries and barriers found in the prior art. The date gap is defined as the number of days (or, more generally, the amount of time) between the event in question and the previous event, and the average number of days between events becomes the center line or standard against which trends and patterns may be identified. Thus, using date gap analysis, data can be displayed as discrete individual events rather than monthly or quarterly conglomerative reports.

After performing date gap analysis, the control chart analysis is performed and the results thereof displayed in tabular or graphical form. The graphical format represents the date gap between successive events plotted in temporal sequence, which allows for quick visual identification of slow and gradual trends as well as rapid changes in the frequencies of events. The graphical format also includes control limits computed based upon the variability of the date gaps, which allow the user to easily separate special causes of variation (“signals”) from common cause of variation (i.e., random noise). Data quality checking is provided in the form of control limits representing variation beyond that expected from common causes. When a data gap exceeds the upper control limit, a reporting irregularity may be indicated and should be investigated.

The signals are selectable in order to “drill down” through layers of control charts to uncover pertinent underlying data about the event corresponding to the signal. This feature allows for aggregated data to be further refined and presented as a more data-focused control chart. In a health care setting, for example, a user monitoring needlesticks may identify a signal in the graphical presentation of needlestick data for the entire facility. In investigating this signal, the user may wish to display needlestick data for each department. This sort of investigation is facilitated by the drill down feature. Using this feature, department specific control charts can be generated immediately to determine if the signal remains or disappears. In the prior art, acquiring and formatting this data would take several hours or days to complete.

These and other advantages of the present invention are further described in the section entitled DETAILED DESCRIPTION OF A PREFERRED EMBODIMENT, below.

### BRIEF DESCRIPTION OF THE DRAWING FIGURES

A preferred embodiment of the present invention is described in detail below with reference to the attached drawing figures, wherein:

FIG. 1 is a block diagram of computer hardware and code segments which may be used to implement a preferred embodiment of the present invention.

FIG. 2 is a flow diagram broadly depicting the steps of a preferred embodiment of the method of the present invention.

FIG. 3 is a conventional X-bar control chart showing a range of plotted data moving about a centerline and bounded, for the most part by, control limits.

FIG. 4 is control chart resulting from a preferred embodiment of the present invention.

### DETAILED DESCRIPTION OF A PREFERRED EMBODIMENT

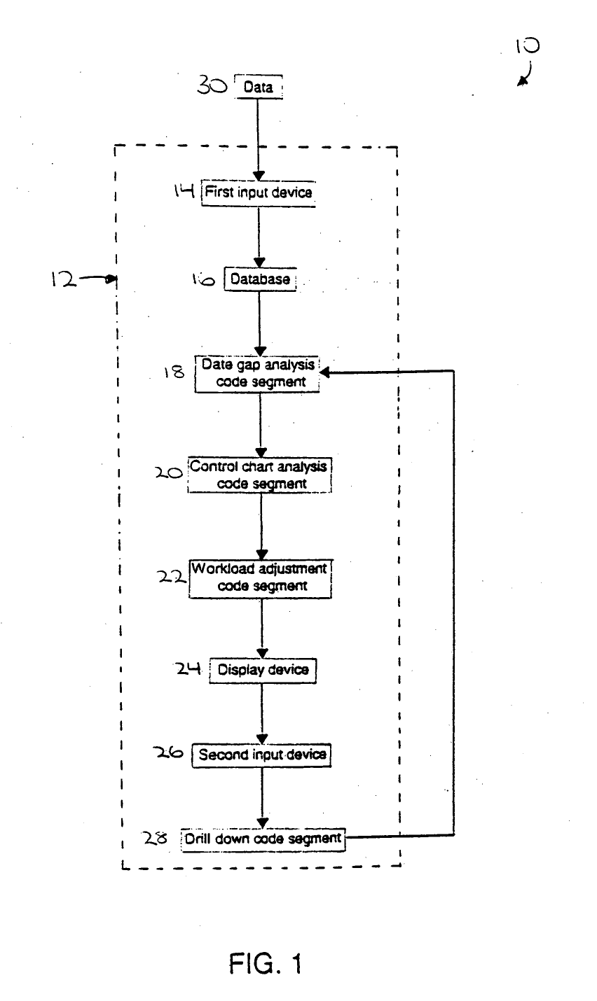

FIG. 1 illustrates a preferred embodiment of a computer-based system 10 for monitoring and analyzing workplace illnesses and injuries. Though described and illustrated in terms of this specific application, the present invention has broad applicability to identifying, monitoring, analyzing, and investigating almost any trend or pattern of interest within an organization. The system 10 comprises a computer 12 having a first input device 14; a database 16; a date gap analysis code segment 18; a control chart analysis code segment 20; a workload adjustment code segment 22; a display device 24; a second input device 26; and a drill down code segment 28.

The computer 12 is preferably operable to receive input from the first and second input devices 14,26, store the database 16, execute the code segments 18,20,22,28, and generate output signals for controlling the display device 24. Any of these functions, in whole or in part, may be performed or assisted by other peripheral or supplemental devices accessed directly or indirectly by the computer 12 such that the resulting hardware, software, firmware, or combination thereof operates to achieve the required functions of the present invention. Thus, the computer 12 may be any computing device, including a single central computer or a plurality of networked computers, with hardware and software resources sufficient to perform the functions required of it by the present invention. Likewise, the computer 12 may utilize any operating system compatible with those functions, and is preferably able to execute the code segments 18,20,22,28 written in any programming language, including JAVA or C++, as a matter of design choice, if provided with sufficient supporting resources (e.g., code compilers).

The first input device 14 provides an interface for receiving administrative input data 30, being worker illness and injury data in the present illustrative description, and providing such data to the database 16. The first input device 14 may be any conventional input device, including a keyboard, scanner, or optical reader. The data 30 may be provided in any form useable by the input device 14, including hardcopy or electronic forms. Any required formatting may be performed by a formatting code segment (not shown) that converts the raw input data into a form suitable for subsequent storage in the database and use by the code segments 18,20,22,28.

The database 16 serves as an easily accessible repository for data received via the first input device 14. The database 16 may be a single large general data repository or a plurality of smaller linked data-specific databases, and may be located in a memory storage device forming a part of the computer 12, or may be located in and accessed from one or more remote memory storage devices. Where the database 16 is located remotely, access thereto is preferably accomplished via a local area network, the Internet, or a similar communications network.

The date gap analysis code segment 18 operates to eliminate the dilution of data that arises with quarterly or monthly data infusions, and is particularly useful for analyzing rare events. The “date gap” is simply the number of days between successive events, and a typical date gap strategy looks at the days between incidents rather than the incident rate. The date gap analysis code segment 18 also standardizes the units of measure, making it easier to see relationships when comparing data, as, for example, between data sets in a multi-windowed display format.

The control chart analysis code segment 20 is executed following execution of the date gap analysis code segment 18 and operates to clearly show the range of normal variation in any process, thereby emphasizing any non-normal variation. Control chart analysis is well-known, particularly in manufacturing, and involves performing various general and application-specific statistical algorithms and operations on the data. Control charts may include plotted averages, plotted ranges, X-bar, and other statistically meaningful graphs.

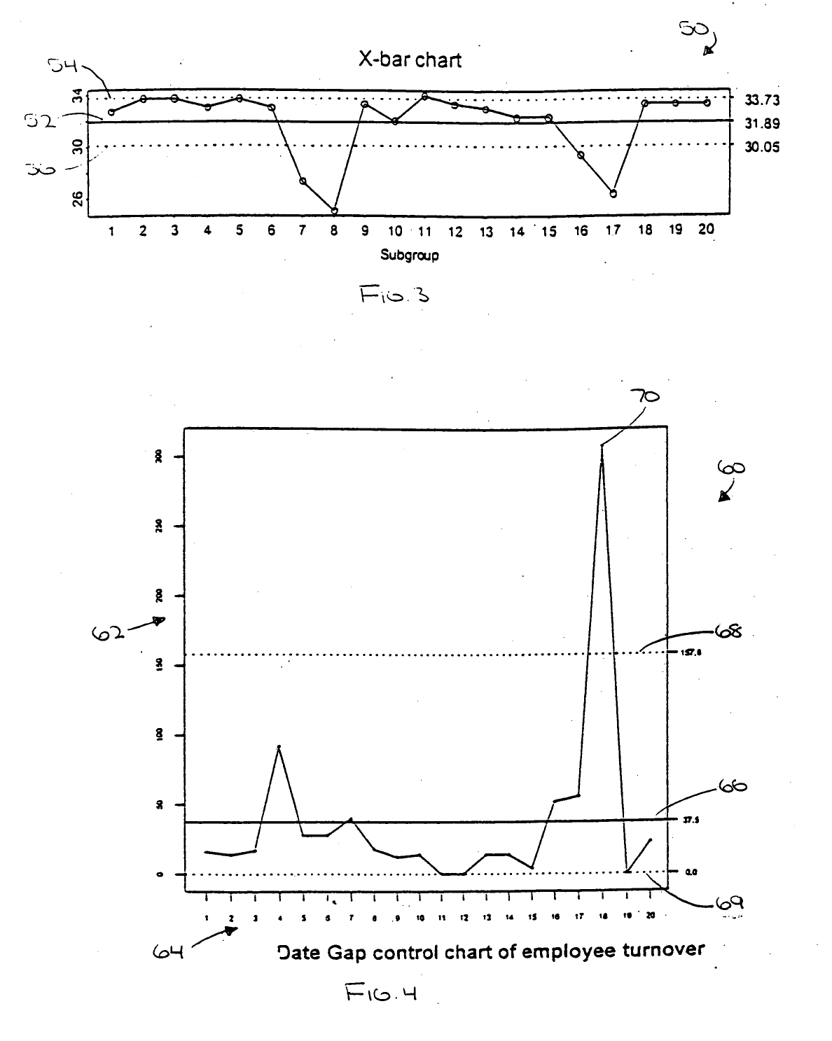

FIG. 3 shows an X-bar control chart 50 which plots data in sequence with a center line 52 at the overall average and upper and lower control limits 54,56 computed at a fixed number of standard deviations from the center line 52. The control chart 50 emphasizes, preferably using special symbols, signals that represent data points exceeding expected normal variation.

Rules may be incorporated into the control chart analysis for identifying special causes of signals. The present invention preferably incorporates only two such rules: Rule 1: A single point outside the control limits indicates a sudden large shift in the process. Rule 2: Eight consecutive points on the same side of the centerline are a signal of a special cause variation. Other rules may be used depending on context and application.

The workload adjustment code segment 22 adjusts for workload, so that, when a signal is identified, it can be determined whether workload was a factor in causing the signal. There are a variety of measurements that might require such workload adjustments and a variety of adjustment factors. For example, a sudden surge in the number of workplace accidents might be related to the number of full-time employees (FTEs) or to the number of hours worked. In this situation, to make an adjustment, the present invention computes the daily cumulative total number of FTEs for each day, so that the difference between the cumulative number at the time of the event and the cumulative number at the time of the previous event represents the number of FTE-days between accidents. If a sudden surge in accidents was proportional to a sudden rise in employees, then the FTE-days between accidents would show a flat trend. If not, then the signal persists even after an increase in number of employees has been taken into account. A similar calculation using labor hours would give the number of hours between accidents. If a slowdown in the rate of accidents was associated with a comparable decline in the amount of work done, then this adjustment should show a flat trend.

The control charts resulting from, the computer-executed code segments 18,20,22,28 are presented on the display 24, which may be any conventional or unconventional display, including a computer monitor or television, operable to communicate visually the information produced by the code segments.

FIG. 4 shows another control chart 60 supplemented by date gap analysis and adjusted for work load. The y-axis 62 indicates the number of days between events; the x-axis 64 indicates the number of the event; a centerline 66 indicates the average number of days between events (37.5 days); upper and lower limits 68,69 are calculated using known control chart equations. One signal 70 in particular is immediately obvious as representing an anomaly—an abnormally large time-gap between event occurrences.

The present invention includes the ability to monitor reporting gaps by displaying control limits that represent variation in reporting beyond that expected from common causes. When a date gap exceeds the upper control limit, as does the signal 70 of FIG. 4, it can serve as a warning about reporting frequency. That is, the sudden increase in the number of days between events might represent a change in the diligence of reporting rather than in the actual number of events. For example, the upper control limit on employee accidents might be fourteen days. If two weeks pass without a an accident report, the user is clued to investigate whether employees are too busy or otherwise unable to report accidents as they occur.

A single control chart/date gap analysis cannot, however, reveal whether a particular signal is a real problem (a problematic variation) or a phantom problem (a normal variation). In FIG. 4, for example, it is unclear whether the signal 70 is merely the result of under-reporting. A comparison of multiple control charts of seemingly unrelated, disparate data sets may be needed to determine, from the relationship between variables, the cause of an event. The present invention allows for the integration and cross-referencing of data sets, and for the display of multiple control charts, thereby allowing a user to place events of interest in context with other data sets. Signal 68, for example, might be due to under-reporting which might, in turn, be due to an increased work-load which might, in turn, be due to a large number of overlapping employee vacations. Three different control charts displayed side-by-side or overlappingly would quickly reveal this connection without the need for a costly or time-consuming investigation.

The second input device 26 allows the user to select a desired signal for more detailed analysis, preferably using the drill-down technique described below. The second input device 26 is preferably a conventional computer mouse, but may alternatively be any suitable input device including a light pen, touch sensitive screen, trackball, or keyboard.

The drill-down code segment 28 allows a user to pursue a signal through layers of control charts to the level of detail required to reveal whether the signal is a real problem or a “phantom”. The drill down code segment 28 receives input from the second input device 26 indicating the user's selection of a particular signal, and initiates focused date gap and control chart analyses on the signal data.

Without the ability to drill-down, valuable resources might be blindly expended in an attempt to identify and mitigate future occurrences of an event associated with a signal. Drill-down allows a more detailed analysis of the nature of a signal, thereby possibly revealing that it resulted from a freak occurrence unlikely to arise again and impossible to mitigate practically.

For example, referring again to FIG. 4, the center range of events, 8-15, all occurred within a relatively short time period and fall under Rule 2 (described above) indicating a special cause. If the chart 60 broadly included all events of a given class (all injuries or all illnesses, for example), then it would be unclear whether events 8-15 represented a related outbreak of one specific type of event (back sprains, for example) or merely a number of unrelated events (back sprains, allergic reactions, needle sticks, etc.). The former would indicate a more specific problem and call for more focused intervention. Thus, drill-down allows an operator to simply and efficiently determine with specificity the cause of such data anomalies and the appropriate response.

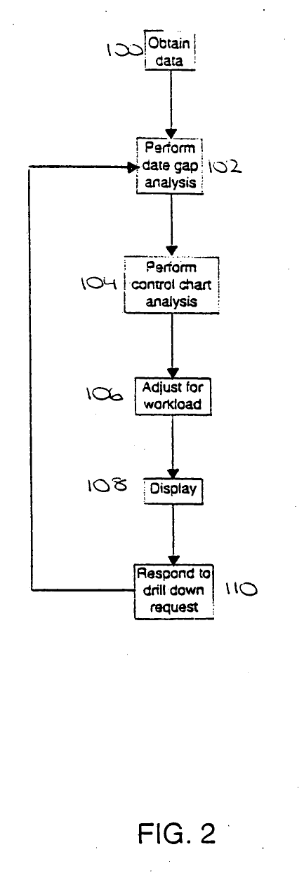

Referring to FIG. 2, a preferred embodiment of the method of the present invention, corresponding to the above described computer-based system, is shown comprising four major steps: obtaining worker illness and injury data, as depicted in box 100; performing date gap analysis, as depicted in box 102; performing control chart analysis, as depicted in box 104; performing workload adjustments, as depicted in box 106; displaying results, as depicted in box 108; and responding to drill-down, as depicted in box 110.

The step 100 of obtaining worker illness and injury data broadly involves the receipt, formatting, and storage of relevant data, preferably on a daily basis. Examples of relevant data include, as applicable, the nature, time, date, and place of each illness or injury, as well as the names of other employees involved. The nature of the data may change for particular applications.

Depending on the scope of the data, it may be preferable to separate the data into data sets based upon a predetermined separation criteria. For example, if data is received broadly involving employee vacations, sick leave, injuries, illnesses, hirings and firings, and reprimands, it may be preferable to separate the data into smaller, more coherent data sets. Separate analyses of the data sets may be subsequently performed and the results compared in order to identify relationships.

The steps 102,104 of date gap and control chart analysis combine to cover both ongoing processes and rare events to provide comprehensive coverage and the ability to produce a “snapshot” of the surveillance data for any time period. Specifically, the step 102 of date gap analysis is performed first to eliminate the dilution of data that arises with quarterly or monthly data infusions, as described above, and is particularly useful for analyzing rare events. The step 104 of control chart analysis allows the user to clearly see the range of normal variation in any process, thereby emphasizing any non-normal variation.

The step 106 of work load adjustment involves adjusting data for workload, so that, when a signal is identified, it can be determined whether workload was a factor in causing the signal. Other data streams are also amenable to workload adjustments. In a hospital setting, for example, it may be desirable to adjust the number of complaints by the number of patients seen at the hospital. It may also be desirable to adjust the number of medication errors by the amount of medication dispensed. If, after normalizing the data with these workload adjustments, the signals persist, then it will at least be known that the cause of the signal is not artificially inflated by workload issues. All such workload adjustments are preferably performed automatically for the user.

The step 108 of display involves tabularly or graphically communicating the results of the above described analysis and adjustment steps 102,104,106. An exemplary date-gap-supplemented, workload-adjusted control chart display is shown in FIG. 4. An advantage of the present invention is that it is capable of simultaneously displaying multiple control charts, thereby facilitating comparative analysis. From the display, anomalous signals will be clearly visible as exceeding established control limits.

The step 110 of drill-down analysis involves pursuing such signals through layers of control charts to the level of detail required to reveal whether the signal is a real problem or a “phantom”. The user simply selects a particular signal of interest to initiate focused date gap and control chart analyses on the underlying signal data.

From the preceding description, it can be understood that the present invention combines the analytical power of control charts with date gap analysis, work load adjustment, and the ability to drill-down through levels of detail for detailed investigation of data underlying anomalous signals exceeding expected variation, all of which makes it an efficient and effective tool for identifying, monitoring, and analyzing trends and patterns of interest within an organization to facilitate proactive intervention where appropriate.

Although the invention has been described with reference to the preferred embodiment illustrated in the attached drawings, it is noted that equivalents may be employed and substitutions made herein without departing from the scope of the invention as recited in the claims. Those skilled in the art will appreciate, for example, that the control chart analysis may include various application-specific statistical algorithms and special case rules.

Furthermore, the combination of computer code segments operable to implement the present invention may be distributed across an interconnected computer network. For example, data input could occur using personal computers at multiple locations throughout the nation, and the data communicated to regional sites using a communications network such as the Internet. Computers at the regional sites could perform formatting and preliminary analysis and send the results to a national site where final analysis and display could be performed. Copies of the data may be stored in any or all of the computers involved in the distributed process.

Having thus described the preferred embodiment of the invention, what is claimed as new and desired to be protected by Letters Patent includes the following:

1. A computer-readable medium encoded with a computer program for enabling a computer to facilitate statistical analysis of events, the computer program comprising code segments for:
receiving data relating to the events;
determining an elapsed time between each event, determining an average elapsed time of the events, and determining an elapsed time control limit; and
generating an output indicating the elapsed time between each event, the average elapsed time of the events, and the elapsed time control limit.

2. The computer-readable medium as set forth in claim 22, further comprising a code segment for determining two elapsed time control limits, wherein each control limit corresponds to a value that differs from the average by a value equal to one or more standard deviations of the data relating to the events.

3. The computer-readable medium as set forth in claim 23, further comprising a code segment for generating a graph that includes a reference centerline corresponding to the average elapsed time, control lines corresponding to the control limits, and points illustrating each elapsed time, wherein the graph visually illustrates a relationship between each point, the centerline, and the control lines.

4. The computer-readable medium as set forth in claim 23, wherein the control limits represent extremes of the data for a process that is in control.

5. The computer-readable medium as set forth in claim 22, further comprising a code segment for converting the data to a standard unit of measure.
